(19) United States
(12) Patent Application Publication
(10) Pub. No.: US 2001/0032411 A1
(43) Pub. Date: Oct. 25, 2001

(54) Angling lure

(76) Inventor: Melvyn Spence, Shipton-by-Beningborough (GB)

Correspondence Address: Kenneth I. Kohn, Kohn & Associates, Suite 410, 30500 Northwestern Hwy., Farmington Hills, MI, 48334, US

(21) Appl. No.: 09/800,794

(22) Filed: Mar. 7, 2001

(30) Foreign Application Priority Data
Mar. 7, 2000 (GB) UK 00 05450.2

(51) Int. Cl. A01K 85/00

(52) U.S. Cl. 43/42.24; 43/42.1

(57) ABSTRACT

The lure 10 comprises a main body part 12, head part 14 and a tail part 16. Extending from the central portion of the main body portion are three pairs of elongate members 22 formed so as to represent legs, for example the legs of a particular species or type of insect. The lure is simply assembled by inserting the angling hook 36 into a U-shaped channel 18 which is provided in each of the head 14, main body 12 and tail 16, either closely adjacent to each other or with spaces therebetween.

### FIELD OF THE INVENTION

The present invention relates to a lure for attachment to an angling hook.

### BACKGROUND TO THE INVENTION

Conventional artificial fly lures comprise bundles and parts of feathers and fur tied together which, when attached to the hook and cast in or on the water, mimic the appearance of an insect.

However, such lures (known as feather flies) are not in most cases particularly close in appearance to the insect they are supposed to mimic, and are also difficult and time consuming to assemble. There is therefore a requirement for an improved lure which more accurately represents the insect, or at least parts thereof, it is intended to mimic, whilst at the same time being both convenient and versatile in use.

### SUMMARY OF THE INVENTION

According to a first aspect of the present invention there is provided a lure for attachment to an angling hook, the lure including at least a main body having a central part with means for receiving the hook and a plurality of elongate members extending from the central part.

Preferably, the means for receiving the hook comprises a generally U-shaped channel in the central part, extending along the longitudinal axis of the main body.

Preferably, there are at least two elongate members, arranged in a pair on opposite sides of the central part.

More preferably, there are three pairs of elongate members, arranged in pairs along opposite sides and spaced along the length of the central part. The elongate members may be separately formed either in pairs or singly and subsequently attached to the hook individually. Accordingly, each elongate member or each pair of elongate members may have a central part which forms the main body.

Preferably, the elongate members are each shaped such that they taper down in diameter from the end proximal to the central part towards the distal end, so as to represent insect legs.

Preferably, the proximal region of each elongate member extends laterally and slightly upwardly with respect to the central part, whereas the more distal regions of each elongate member extend laterally and downwardly with respect to the central part, so as to mimic the natural three dimensional configuration of an insect body and legs.

The elongate members and the central part may be integrally formed, or alternatively the elongate members may be separately formed either in pairs or singly and subsequently attached to the central part. The elongate member may be separately formed either in pairs or singularly and subsequently attached to the hook individually. Accordingly, each elongate member or each pair of elongate members may have a central part which forms the main body.

Preferably, the lure also includes a separate tail part having a central portion with means for receiving the hook and one or more elongate members extending therefrom generally parallel and/or at an acute angle to the longitudinal axis of the central portion.

Preferably the lure also includes a head part having a central portion with means for receiving the hook and one or more elongate members extending generally parallel and/or at an acute angle to the longitudinal axis of the central portion.

Conveniently, the lure is manufactured from rubber, plastics or rubber or plastics based composite materials, and is preferably moulded using known high pressure moulding techniques.

Preferably, the main body and/or the head part and/or the tail part are manufactured in a variety of different shapes each designed to mimic a particular species or type of insect or its nymph or larval form.

In use, the angler would secure the hook into the hook receiving means (e.g. the U-shaped channel) of each of the main body, head and tail parts by means of glue or the like. Alternatively, just the main body bearing the “legs” may be used and could be sufficient in certain circumstances.

By altering the distance between the head part, main body and tail part, or by using a differently shaped head part, main body or tail part, different species or type of insect (either aquatic or terrestrial), may be mimicked.

Preferably, the head part, main body and tail part are of a colour, shade or mix of colours, to represent or accurately match the colours of the natural insect (or its nymph or larval form) that the lure is intended to mimic.

Preferably, the head part, main body and tail part have various different surface finishes, to represent or accurately match the outer skins of the natural insect (or its nymph or larval form) that the lure is intended to mimic.

According to a second aspect of the present invention there is provided a kit of parts for making up a lure, comprising a head part, a body part, and a tail part, each of said parts having a central portion with means for receiving an angling hook, and at least one elongate member extending from the central portion.

According to a third aspect of the present invention there is provided a method of assembling a lure comprising securing to an angling hook a main body having a central part and a plurality of elongate members extending from the central part.

Preferably, the method also includes securing to the angling hook adjacent said main body a head part having a central portion and one or more elongate members extending generally parallel and/or at an acute angle to the longitudinal axis of the central portion.

More preferably, the method also includes securing to the angling hook a tail part having a central portion with one or more elongate members extending therefrom generally parallel and/or at an acute angle to the longitudinal axis of the central portion.

According to a fourth aspect of the present invention there is provided a lure for attachment to an angling hook, the lure including elongate members, the elongate members comprising at least a first section and a second section wherein the second section extends at a predetermined angle to the first section.

The elongate members may comprise a third section at a predetermined angle to the second section. The elongate members may comprise a fourth section at a predetermined angle to the third section. The elongate members may comprise a fifth section at a predetermined angle to the fourth section.

The sections of the elongate members preferably extend numerically along the elongate members.

Preferably the elongate members are each shaped such that they taper down in diameter from the end arranged to be proximal to the hook towards the distal end, so as to represent insect legs.

The elongate members may be secured to the hook by a thread.

The elongate members may be manually secured to the hook.

The elongate members may be individually secured to the hook.

The elongate members may be secured to the hook in pairs.

Preferably the members are arranged in pairs in which the elongate members in the pair are arranged to extend outwardly in opposite directions from the hook. The lure may comprise one pair, or two pair or preferably three pairs of elongate members. Preferably the sections of a first elongate member are angled and spaced substantially identical to the second elongate member in the pair. The sections of the elongate members in a first pair may be spaced and angled differently compared to the section of the elongate members in a second pair and preferably to the sections of the elongate members in a third pair. Accordingly, the elongate members may mimic a front pair of legs, a middle pair of legs and a rear pair of legs.

Preferably the sections are angled relative to each other prior to securement to the hook.

Preferably the elongate members are formed by an extrusion method.

According to a fifth aspect of the present invention there is provided a kit of parts for making up a lure comprising a head part, a body part, and a tail part, the lure comprising elongate members having at least a first section and a second section wherein the second section extends at a predetermined angle from the first section.

According to a sixth aspect of the present invention there is provided a method of making a lure for attachment to an angling hook, the method including forming an elongate member comprising at least a first section and a second section wherein the second section extends at a predetermined angle from the first section.

Preferably the method comprises extruding the elongate members.

Any feature of any aspect of any invention or embodiment described herein may be combined with any feature of any aspect of any other invention or embodiment described herein.

### BRIEF DESCRIPTION OF THE DRAWINGS

Embodiments of the present invention will now be described by way of example only with reference to the accompanying drawings in which:

FIG. 1 illustrates in plan view the appearance of the main body part;

FIG. 2 shows the detail of the U-shaped hook receiving channel;

FIG. 3 illustrates a pair of legs form separately;

FIG. 4 illustrates a single leg formed separately;

FIG. 5 and FIG. 6 illustrate different shapes of tail portion;

FIG. 7 illustrates a head portion;

FIG. 8 illustrates how the main, head and tail portions are attached to the hook in use; and

FIG. 9 illustrates a further embodiment of the present invention.

### DESCRIPTION OF THE PREFERRED EMBODIMENTS

Referring to the drawings an artificial lure 10 according to the present invention comprises, in the preferred embodiment, a main body part 12, a head part 14 and a tail part 16.

Each of these parts includes in a central portion thereof a U-shaped channel 18 such as that shown in FIG. 2.

Extending from the central portion 20 of the main body portion 12 are three pairs of elongate members 22 formed so as to represent the legs of the particular species or type of insect or its nymph or larval form, these “legs” 22 being arranged in pairs along the central portion 20.

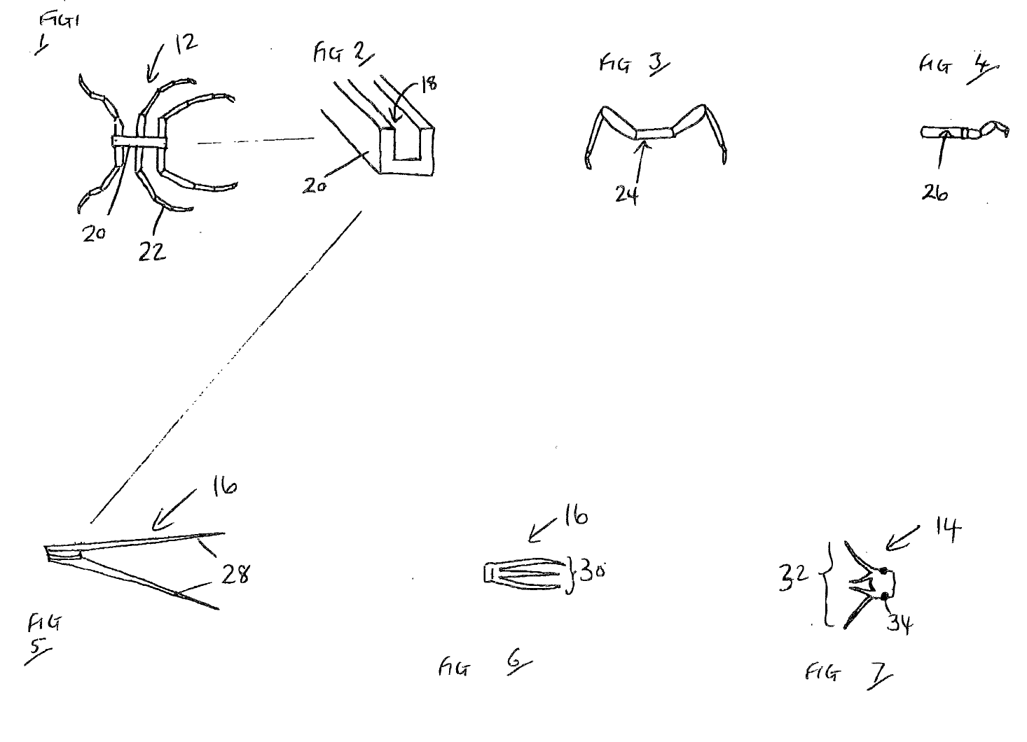

Whilst in the preferred embodiment the “legs” 22 are integrally formed with the central portion 20, in an alternative embodiment the legs may be formed as a pair 24 as shown in FIG. 3 or as a single leg 26 as shown in FIG. 4. Sufficient numbers of these leg pairs or legs would then be provided to make up the complete main body part as shown in FIG. 1.

In an alternative embodiment of the present invention, the legs are separately formed either in pairs or singly and subsequently attached to the hook individually. Each leg or pair of legs has a central part including U-shaped channel in order to secure the leg or pair of legs to the hook. The central part of the or each leg or pair of legs thereby forms the main body of the lure.

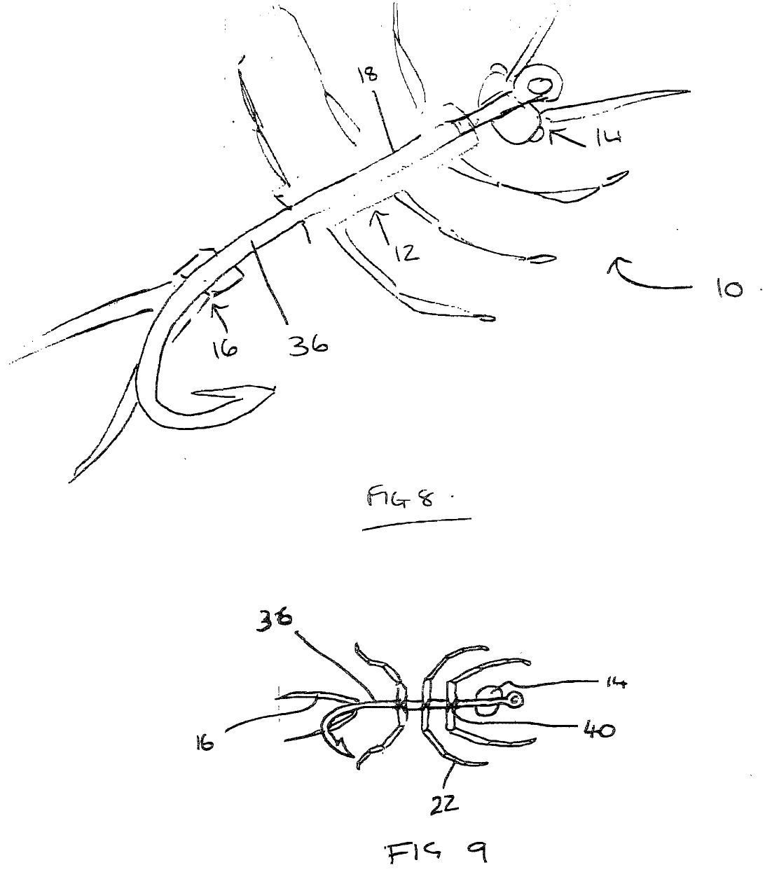

The tail part 16 (of which two possible variants are shown in FIGS. 5 and 6) have two or more elongate members 28, 30 extending generally parallel and/or at an acute angle with respect to the longitudinal axis of the lure.

Similarly, the head portion 14 has a number of elongate members 32 extending generally parallel and/or at various different acute angles to the longitudinal axis of the lure. Some of these may represent the antennae of the insect that the lure is intended to mimic, whereas others may represent one or more mouth parts. To enhance the effectiveness of the lure the head portion may also include eyes 34.

As shown in FIG. 8, the lure is simply assembled by inserting the angling hook 36 into the U-shaped channel 18 which is provided in each of the head 14, main body 12 and tail 16, either closely adjacent to each other or with spaces therebetween.

In a further embodiment of the present invention the elongate members or legs 22 are secured to the angling hook 36 by securement means in the form of a securement thread 40, as shown in FIG. 9. The lure also comprises a tail portion 16, and a head portion 14. The legs 22 comprise a plurality of sections in order to mimic the sections of the legs of an insect. The lure comprises a pair of front legs, a pair of middle legs and a pair of rear legs. Each leg in the pair comprise identical sections. However, the legs in each pair are different from the legs in another pair.

Each leg may comprise five sections, as shown in FIG. 9, with the legs tapering in diameter from the section of the leg adjacent to the hook to the end of the leg. Accordingly, the legs accurately mimic the legs of a particular insect. In prior art methods the legs are initial straight and secured to the hook. It is possible to attempt to bend the prior art legs in order to imitate a joint, for example by heating the leg. However, such manual methods result in the joints being haphazardly spaced and at an uncontrolled angle. This is particularly noticeable since the legs in a pair will be significantly different.

The legs are formed using known extrusion techniques. Accordingly, legs are provided preformed and do not require any subsequent manipulation once secured to the angling hook 36.

It is envisaged that a wide variety of different head, main and tail portions and legs would be manufactured, in order to give a wide range of different lures, each representing a particular species or type of insect or its nymph or larval form.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extend to any novel one, or any novel combination, of the features disclosed in this specification (including any accompanying claims, abstract and drawings), or to any novel one, or any novel combination, of the steps of any method or process so disclosed.

1. A lure for attachment to an angling hook, the lure including at least a main body having a central part with means for receiving the hook and a plurality of elongate members extending from the central part.

2. A lure according to claim 1 in which the means for receiving the hook comprises a generally U-shaped channel in the central part, extending along the longitudinal axis of the main body.

3. A lure according to claim 1 in which there are at least two elongate members, arranged in a pair on opposite sides of the central part.

4. A lure according to claim 1 in which there are three pairs of elongate members, arranged in pairs along opposite sides and spaced along the length of the central part.

5. A lure according to claim 1 in which the elongate members are each shaped such that they taper down in diameter from the end proximal to the central part towards the distal end, so as to represent insect legs.

6. A lure according to claim 1 in which the proximal region of each elongate member extends laterally and slightly upwardly with respect to the central part, whereas the more distal regions of each elongate member extend laterally and downwardly with respect to the central part, so as to mimic the natural three dimensional configuration of an insect body and legs.

7. A lure according to claim 1 in which the elongate members and the central part may be integrally formed.

8. A lure according to claim 1 in which the elongate members may be separately formed either in pairs or singly and subsequently attached to the central part.

9. A lure according to claim 1 in which the elongate members are separately formed either in pair or singularly and subsequently attached to the hook individually.

10. A lure according to claim 1 in which each elongate member or each pair of elongate members has a central part which forms the main body.

11. A lure according to claim 1 in which the lure includes a separate tail part having a central portion with means for receiving the hook and one or more elongate members extending therefrom generally parallel and/or at an acute angle to the longitudinal axis of the central portion.

12. A lure according to claim 1 in which the lure includes a head part having a central portion with means for receiving the hook and one or more elongate members extending generally parallel and/or at an acute angle to the longitudinal axis of the central portion.

13. A lure according to claim 1 in which, the lure is manufactured from rubber, plastics or rubber or plastics based composite materials.

14. A lure according to claim 1 in which the lure is moulded using known high pressure moulding techniques.

15. A lure according to claim 1 in which, in use, the angler would secure the hook into the hook receiving means (e.g. the U-shaped channel) of each of the main body, head and tail parts by means of glue or the like.

16. A lure according to claim 1 in which, in use, the angler would secure the hook into the hook receiving means of just the main body.

17. A kit of parts for making up a lure, comprising a head part, a body part, and a tail part, each of said parts having a central portion with means for receiving an angling hook, and at least one elongate member extending from the central portion.

18. A method of assembling a lure comprising securing to an angling hook a main body having a central part and a plurality of elongate members extending from the central part.

19. A method according to claim 18 including securing to the angling hook adjacent said main body a head part having a central portion and one or more elongate members extending generally parallel and/or at an acute angle to the longitudinal axis of the central portion.

20. A method according to claim 18 including securing to the angling hook a tail part having a central portion with one or more elongate members extending therefrom generally parallel and/or at an acute angle to the longitudinal axis of the central portion.

21. A lure for attachment to an angling hook, the lure including elongate members, the elongate members comprising at least a first section and a second section wherein the second section extends at a predetermined angle to the first section.

22. A lure according to claim 21 in which the elongate members comprise a third section which extends at a predetermined angle to the second section.

23. A lure according to claim 21 in which the elongate members comprise a third section and a fourth section and in which the third section extends at a predetermined angle to the second section and the fourth section extends at a predetermined angle to the third section.

24. A lure according to claim 21 in which the elongate members comprise a third section and a fourth section and a fifth section in which the third section extends at a predetermined angle to the second section and the fourth section extends at a predetermined angle to the third section and the fifth section extends at a predetermined angle to the fourth section.

25. A lure according to claim 21 in which the elongate members are each shaped such that they taper down in diameter from the end arranged to be proximal to the hook towards the distal end.

26. A lure according to claim 21 in which the elongate members are secured to the hook by a thread.

27. A lure according to claim 21 in which the sections are angled relative to each other prior to securement to the hook.

28. A kit of parts for making up a lure comprising a head part, a body part, and a tail part, the lure comprising elongate members having at least a first section and a second section wherein the second section extends at a predetermined angle from the first section.

29. A method of making a lure for attachment to an angling hook, the method including forming elongate members comprising at least a first section and a second section wherein the second section extends at a predetermined angle from the first section.
